(19) United States
(12) Patent Application Publication
(10) Pub. No.: US 2024/0174540 A1
(43) Pub. Date: May 30, 2024

(54) METHODS FOR RECOVERING FLY ASH USING A SELECTIVE FLOCCULANT

(71) Applicant: CHEMTREAT, INC., Glen Allen, VA (US)

(72) Inventor: Alfonso SALINAS, Huber Heights, OH (US)

(73) Assignee: CHEMTREAT, INC., Glen Allen, VA (US)

(21) Appl. No.: 18/522,985

(22) Filed: Nov. 29, 2023

Related U.S. Application Data
(60) Provisional application No. 63/428,965, filed on Nov. 30, 2022.

(51) Int. Cl. C02F 11/147

(52) U.S. Cl. CPC C02F 11/147; C02F 2103/34; C02F 2305/04

(57) ABSTRACT

Methods are described for treating fly ash sludge that includes calcium sulfate and/or calcium sulfite to selectively capture fly ash. The methods include treating the slurry with a first flocculant that selectively captures fly ash in the slurry relative to the calcium sulfate and/or calcium sulfite in the slurry, or alternatively selectively captures the calcium sulfate and/or calcium sulfite in the slurry relative to the fly ash, and clarifying the treated slurry to provide (i) a stream that includes relatively higher amounts of the calcium sulfate and/or calcium sulfate as compared to the slurry, and (ii) a stream that includes relatively higher amounts of the fly ash as compared to the slurry. Further processing of the stream that is enriched in fly ash can provide a high-purity fly ash product.

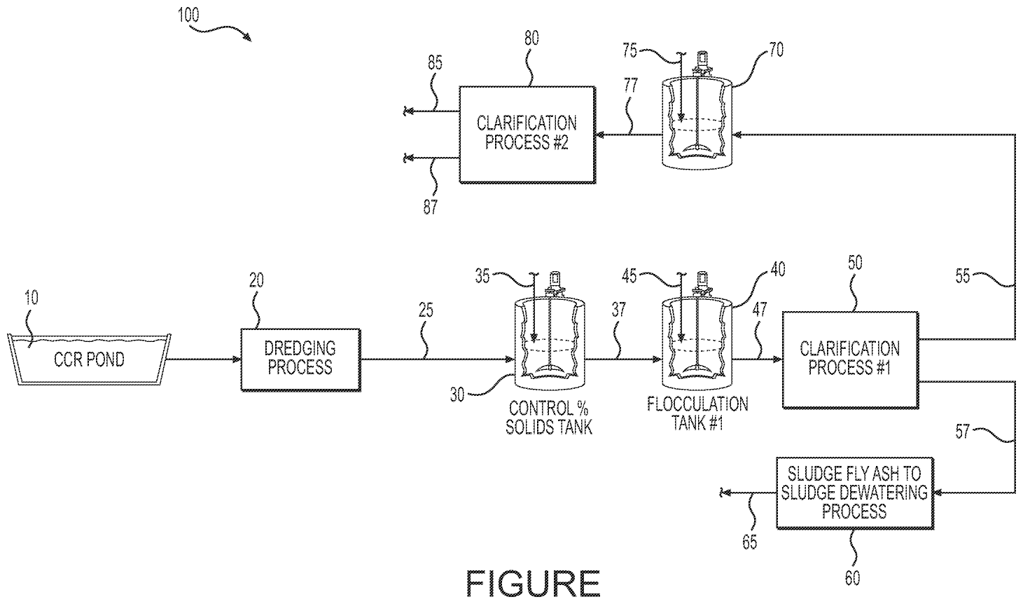

### CROSS-REFERENCE TO RELATED APPLICATION

This application claims the earlier filing date benefit of U.S. provisional patent application 63/428,965, filed on Nov. 30, 2022, which is incorporated by reference herein.

### BACKGROUND

Coal-fired power plants produce fly ash as a combustion residual. Fly ash includes fine particulates that are composed of substantial amounts of silica, alumina, and calcium oxide. Fly ash can also include relatively large amounts of heavy metals, including arsenic, selenium, lead, and mercury. Fly ash has been traditionally stored as a waste product in containment ponds.

Efforts have recently been made to recycle fly ash for various uses, in particular as a lightweight aggregate in the production of cementitious or brick materials. However, waters and sludges containing fly ash can also include other constituents such as calcium sulfate and/or calcium sulfite. Conventional flocculation processes do not adequately separate calcium sulfate and calcium sulfite from fly ash since they have a similar density as fly ash. This may limit the possible uses of the recovered fly ash or reduce its value.

### SUMMARY

An object of the present invention is to produce a fly ash which has been purified by selectively separating specific compounds from the fly ash sludge such as calcium sulfate and/or calcium sulfite. In one aspect, this is accomplished by using one or more flocculants that selectively interact with the fly ash so that the floc includes a purified fly ash with relatively less amounts of calcium sulfate or calcium sulfite.

In one aspect, a method is provided for treating fly ash sludge that includes calcium sulfate and/or calcium sulfite. The method includes combining water with the fly ash sludge to form a slurry, treating the slurry with a first flocculant that selectively captures fly ash in the slurry relative to the calcium sulfate and/or calcium sulfite in the slurry, and clarifying the treated slurry to provide (i) an overflow stream that includes relatively higher amounts of the calcium sulfate and/or calcium sulfate as compared to the slurry, and (ii) a second sludge that includes relatively higher amounts of the fly ash as compared to the slurry.

In another aspect, the method can include combining water with the fly ash sludge to form a slurry, treating the slurry with a flocculant that selectively captures calcium sulfate and/or calcium sulfite in the slurry in the slurry relative to fly ash in the slurry, and clarifying the treated slurry to provide (i) an overflow stream that includes relatively higher amounts of the fly ash as compared to the slurry, and (ii) a second sludge that includes relatively higher amounts of the calcium sulfate and/or calcium sulfate as compared to the slurry.

### BRIEF DESCRIPTION OF THE DRAWINGS

The FIGURE is a schematic diagram of a process that uses selective flocculants to produce purified fly ash.

### DETAILED DESCRIPTION OF EMBODIMENTS

As indicated above, fly ash sludge from coal combustion plants can include calcium sulfate and/or calcium sulfite. In one aspect, this invention relates to methods for recovering purified fly ash using selective flocculants that are each able to preferentially capture either (i) fly ash, or (ii) calcium sulfate/calcium sulfite, to create a high purity and high density floc.

The FIGURE illustrates an exemplary system 100 for producing purified fly ash. As shown in the FIGURE, a coal combustion residuals (CCR) pond 110 has sludge with fly ash and calcium sulfate (CaSO₄) and/or calcium sulfite (CaSO₃). The sludge can be dredged in dredging process 20 to produce a high-solids slurry 25 (which is also referred to as fly ash sludge). The dredging can be performed with hydraulic pumps located at the edge of the pond 110 or on a boat that is on the pond, or by using an excavator from the edge of the pond, for example. The dredging can be performed and the dredged sludge can have a total solids content that is in a range of from 20 wt. % to 80 wt. %, from 40 wt. % to 75 wt. %, or from 50 wt. % to 65 wt. %. The high-solids slurry can be passed to a first tank or container (Solids Tank 30), and the slurry can be diluted with water 35 to decrease the solids content. The dilution allows for solids dispersion and improves separation. After this dilution step, the diluted slurry 37 may have total solids content that is in a range of from 5 wt. % to 30 wt. %, or from 10 wt. % to 20 wt. %, for example. The amount of dilution can be determined on a case-by-case basis.

The diluted slurry 37 can then be conveyed to a first flocculation tank 40 (Flocculation Tank #1). In this embodiment, a first selective flocculant 45 is added to the first flocculation tank 40 that selectively captures the fly ash to the relative exclusion of calcium sulfate/calcium sulfite, and produces a high density, high purity floc. The floc can have a specific density in a range of from 1.1 to 2.5, for example.

The floc mixture 47 can be separated by allowing the mixture to settle in a clarification tank 50 (Clarification Process #1) to provide (i) a sludge 57 that has relatively higher amounts of fly ash as compared to the high-solids slurry and relatively lower amounts of calcium sulfate/calcium sulfite as compared to the high-solids slurry, and (ii) an overflow 55 that includes relatively higher amounts calcium sulfate/calcium sulfate as compared to the high-solids slurry and relatively lower amounts of fly ash as compared to the high-solids slurry. The sludge 57 may have an amount of fly ash that is greater than 80 wt. % on a dry basis. The overflow 55 may have a combined amount of calcium sulfate and calcium sulfite that is more than 80 wt. % on a dry basis. Other clarification systems that can be used to clarify the floc mixture include a plate clarifier, a solid contact clarifier, ballasted clarification, membranes, etc.

Once the sludge 57 is separated from the overflow in Clarification Process #1, the sludge can be further dewatered in dewatering process 60. The dewatering process 60 may include a plate and frame filter press, belt press, screw press, geotubes, centrifuge, or a combination of the foregoing, for example. The dried and recovered fly ash 65 has a high purity (e.g., 80 wt. % fly ash to 99.9 wt. % fly ash, more than 95 wt. % fly ash, or more than 99 wt. % fly ash). In determining the purity of the fly ash, calcium sulfate, calcium sulfite, clay, and soil are considered as impurities. The recovered fly ash can be used in a variety of industries, in particular as an aggregate for cement.

The clarifier overflow 55 includes the bulk of the calcium sulfate and/or calcium sulfite from the slurry. In this embodiment, the overflow can be treated with another selective flocculent 75 in a second flocculation tank 70 (Flocculation Tank #2) to selectively capture calcium sulfate and/or calcium sulfite. The floc from the second flocculation step can be separated by settling the floc mixture 77 in a second clarification process 80 (Clarification Process #2). The second clarification process 80 can also include the various clarification systems described above. The sludge 87 from the second clarification process 80 is relatively rich in calcium sulfate and/or calcium sulfite, and can include most of the calcium sulfate and/or calcium sulfite that was present in the sludge 25. The sludge 87 can be dewatered and sent to a landfill or reused (e.g., in gypsum production). The overflow 85 from the second clarification process 80 can be discharged or recirculated, e.g., as the diluent water 35.

In this embodiment, the flocculant that is selective to fly ash is added to the first flocculation process, and the flocculant that is selective to the calcium sulfate/calcium sulfite constituent is added to the second flocculation process. However, in some embodiments, the order could be reversed. In this regard, the order of selective flocculation can be chosen based on which of those two constituents is present at a higher concentration. In some embodiments, only one of the flocculation steps may be needed or desired.

In some embodiments, an additional selective flocculant can be added for sludge thickening and sludge dewatering. The additional selective flocculant can be added to the sludge dewater process 60, for example, to improve water release (i.e., a quicker release and/or more volume) to reduce time and increase the solids concentration of the final product.

In one aspect, the invention provides a polymeric flocculent that is modified to selectively capture fly ash. In another aspect, the invention provides a different polymeric flocculent that is modified to selectively capture calcium sulfate or calcium sulfite.

The selective flocculant can be a polymeric flocculant, in a particular a polyacrylamide or a biopolymer, or a combination of a polyacrylamide and a biopolymer. The polymeric flocculant can be anionic. The polymeric flocculants can be designed to selectively capture the constituent of interest. Thus, in the first flocculation process described above, a selective flocculant can be designed to selectively capture fly ash to the relative exclusion of calcium sulfate and calcium sulfite. This can be accomplished by modifying the surface charge of the polymeric flocculant so that it selectively captures the desired constituents. For example, a polyacrylamide flocculant can be modified by reacting it with other chemical products, such as surfactant compounds, and/or by neutralizing charges that are present on the surface of the polymer particle. Without intending to be bound by theory it is believed that polymeric flocculants can be modified in this way to match the opposite surface charge of the constituent of interest in fly ash sludge, so that the flocculent has a very close, but opposite charge, thereby selectively capturing the constituent of interest. It may also be possible to selectively exclude certain constituents from the floc by identifying sites on the polymer that have an affinity for those constituents and modifying the polymer to block those sites. For example, to provide a flocculent that selectively captures fly ash in the first flocculation process described above, it may be possible to block sites on the polymeric flocculant that have an affinity to calcium sulfate or calcium sulfite. In the second flocculation process described above, a selective flocculant can be design to selectively capture calcium sulfate and/or calcium sulfite. In some aspects, this flocculant can also be a polymeric flocculant (e.g., anionic polymer) having a smaller molecular weight than the selective flocculant that is used to capture the fly ash in the first flocculation process.

While the invention has been described in conjunction with the specific exemplary embodiments thereof, it is evident that many alternatives, modifications, and variations will be apparent to those skilled in the art. Accordingly, exemplary embodiments of the invention as set forth herein are intended to be illustrative, not limiting. There are changes that may be made without departing from the spirit and scope of the invention.

What is claimed is:

1. A method for treating fly ash sludge that includes calcium sulfate and/or calcium sulfite, the method comprising:
combining water with the fly ash sludge to form a slurry;
treating the slurry with a first flocculant that selectively captures fly ash in the slurry relative to the calcium sulfate and/or calcium sulfite in the slurry; and
clarifying the treated slurry to provide (i) an overflow stream that includes relatively higher amounts of the calcium sulfate and/or calcium sulfate as compared to the slurry, and (ii) a second sludge that includes relatively higher amounts of the fly ash as compared to the slurry.

2. The method of claim 1, further comprising dewatering the second sludge to produce a recovered fly ash product.

3. The method of claim 2, wherein the recovered fly ash product has a fly ash content that is in a range of from 80 wt. % to 99.9 wt. %.

4. The method of claim 1, further comprising treating the overflow stream with a second flocculant that selectively captures calcium sulfate and/or calcium sulfite.

5. The method of claim 4, further comprising clarifying the treated overflow stream to provide a third sludge that includes most of the calcium sulfate and/or calcium sulfite from the slurry.

6. The method of claim 4, wherein the third sludge includes more than 80 wt. % of calcium sulfate and calcium sulfite on a dry basis.

7. The method of claim 1, wherein the first flocculant is a polymeric flocculant.

8. The method of claim 7, wherein the polymeric flocculant includes at least one of a polyacrylamide and a biopolymer.

9. The method of claim 7, wherein a surface charge of the polymeric flocculant is modified to have an opposite charge of a constituent in the fly ash sludge.

10. The method of claim 7, wherein the polymeric flocculant is a polyacrylamide.

11. The method of claim 10, wherein a surface charge of the polyacrylamide is modified by reacting the polyacrylamide with a surfactant.

12. The method of claim 4, wherein the first flocculant is a polymeric flocculant and the second flocculant is a polymeric flocculant.

13. The method of claim 12, wherein the second flocculant has a molecular weight that is smaller than the first flocculant.

14. The method of claim 1, wherein the fly ash sludge has a solids content that is in a range of from 20 wt. % to 80 wt. %.

15. The method of claim 1, wherein the slurry has a solids content that is in a range of from 5 wt. % to 30 wt. %.

16. The method of claim 1, wherein the treated slurry is a floc mixture having floc with a specific density that is in a range of from 1.1 to 2.5.

17. The method of claim 1, further comprising a step of providing the fly ash sludge by dredging the fly ash sludge from a coal combustion residuals pond.

18. A method for treating fly ash sludge that includes calcium sulfate and/or calcium sulfite, the method comprising:
combining water with the fly ash sludge to form a slurry;
treating the slurry with a flocculant that selectively captures calcium sulfate and/or calcium sulfite in the slurry in the slurry relative to fly ash in the slurry; and
clarifying the treated slurry to provide (i) an overflow stream that includes relatively higher amounts of the fly ash as compared to the slurry, and (ii) a second sludge that includes relatively higher amounts of the calcium sulfate and/or calcium sulfate as compared to the slurry.
